(19) United States
(12) Patent Application Publication
(10) Pub. No.: US 2016/0321567 A1
(43) Pub. Date: Nov. 3, 2016

(54) PROJECTION DEVICE ACCESS

(71) Applicant: Hewlett-Packard Development Company, Houston, TX (US)

(72) Inventors: Thomas Sandholm, Mountain View, CA (US); Anupriya Ankolekar, Sunnyvale, CA (US)

(21) Appl. No.: 14/701,302

(22) Filed: Apr. 30, 2015

(51) Int. Cl. G06Q 10/02; H04L 9/08

(52) U.S. Cl. CPC G06Q 10/02; H04L 9/0861

(57) ABSTRACT

Examples associated with projection device access are disclosed. One example includes receiving a reservation request of a meeting space for a specified time space. The meeting space has a projection device. A secret key is generated based on the reservation and the secret key is provided to the user. A screen sharing module is also provided to the user. The screen sharing module connects to the projection device using the key, and controls the projection device to project an image into the meeting space. The image is received from a device executing the screen sharing module.

Companies may designate physical locations (e.g., rooms) within their operating spaces as meeting spaces. These meeting spaces may include various projectors and displays that allow meeting attendees to simultaneously view content controlled by, for example, a presenter. The companies may employ a variety of scheduling techniques and/or solutions to reduce competition over meeting room space.

### BRIEF DESCRIPTION OF THE DRAWINGS

The present application may be more fully appreciated in connection with the following detailed description taken in conjunction with the accompanying drawings, in which like reference characters refer to like parts throughout, and in which:

FIG. 1 illustrates example devices and networks, on which example systems, and methods, and equivalents, may operate.

FIG. 2 illustrates a flowchart of example operations associated with projection device access.

FIG. 3 illustrates another flowchart of example operations associated with projection device access.

FIG. 4 illustrates an example system associated with projection device access.

FIG. 5 illustrates another flowchart of example operations associated with projection device access.

FIG. 6 illustrates an example computing device in which example systems, and methods, and equivalents, may operate.

### DETAILED DESCRIPTION

Systems, methods, and equivalents associated with projection device access are described. Access to a projection device in a physical space may be provided by generating a secret key when a user successfully reserves the physical space (e.g., for a meeting) in which the projection device is located. The secret key may also be provided, during the time period associated with the reservation, to an access module that controls access to the projection device. This may allow the user to launch a screen sharing module that facilitates showing images using the projection device. The screen sharing module may make the secret key available to the access module controlling the projection device, which may then allow the screen sharing module to control the projector to project, into the physical space, images provided from the device operating the screen sharing module.

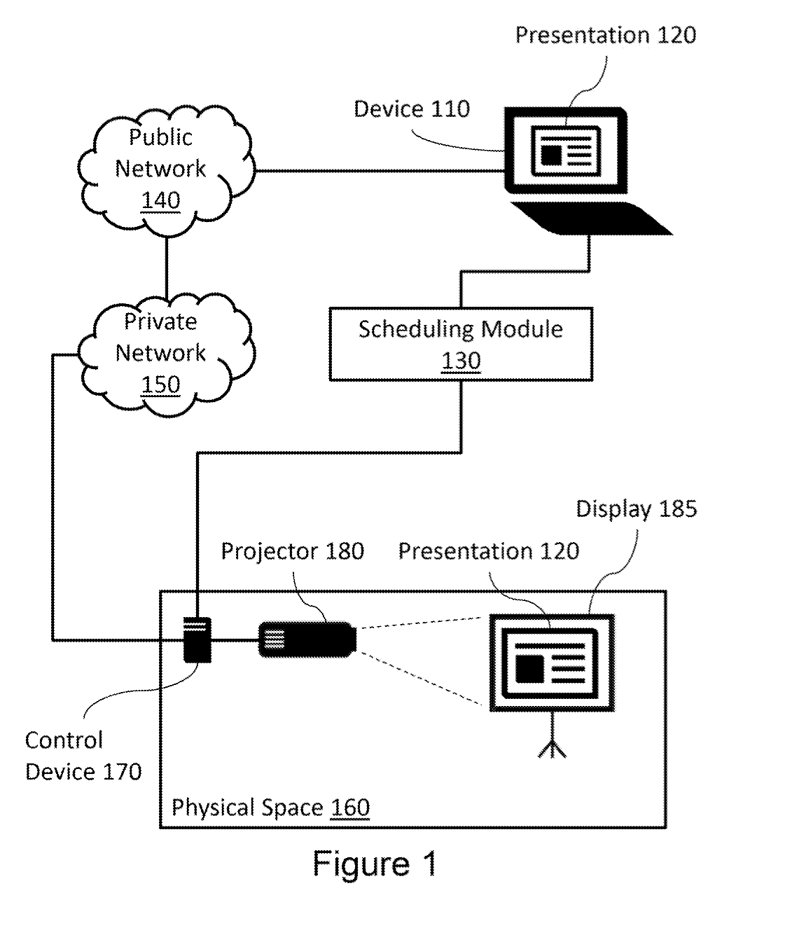

FIG. 1 illustrates example devices and networks in which example systems and methods, and equivalents, may operate. It should be appreciated that the items depicted in FIG. 1 are illustrative examples and many different features and implementations are possible.

FIG. 1 illustrates an example device 110. Device 110 may be, for example, a desktop computer, a laptop computer, a tablet computer, a cellular phone, and so forth. Device 110 may be operated by a user. The user may desire to give a presentation 120 in a physical space 160. Physical space 160 may be equipped with a projector 180 and a display 185. In other examples, physical space 160 may be equipped with a screen (e.g., liquid crystal display), or another technology for projecting images received from device 110 into physical space 160.

However, physical space 160 may be a shared resource that is used, at various times, by many different people from an organization with which the user is associated. This may make physical space 160 a limited resource as multiple people operating within the same space on unrelated tasks may interfere with one another. Consequently, the organization may employ a scheduling module 130 to manage reservations of physical space 160. Scheduling module 130 may manage reservations of physical space 160 by, for example, ensuring persons scheduling reservations have appropriate permissions for reserving physical space 160, ensuring that reservations of physical space 160 do not conflict with each other (e.g., by occurring during overlapping time periods), and so forth.

When the time comes for the user to give their presentation, the user may connect device 110 to projector 180 to cause presentation 120 to be shown on display 185. If the user is physically present with device 110 within physical space 160, device 110 may connect via a cable or local wireless technology (e.g., Bluetooth, a local wireless network) to projector 180. However, when physical cables are used to connect device 110 to projector 180, certain devices 110 may be unable to connect if the proper cable connection does not exist in the device. When wireless networks are used, again assuming the appropriate hardware, applications, and/or operating systems are functioning on device 110, projector 180 and device 110 may need to be on the same network. This may kick device 110 off of another network, potentially preventing device 110 from accessing content intended for display. Further, because these pairings may be remembered by device 110 and projector 180, it may be possible for non-authorized users operating on the network to use projector 180 at the same time as an authorized user user, or for users to inadvertently interfere with one-another's presentations.

Additionally, significant time may be spent setting up projection as the user attempts to figure out the proper cables to connect, settings on device 110 and projector 180, and so forth to cause presentation 120 to be shown on display 185. In other examples, to facilitate the user presenting from a remote location, some organizations setup intermediary computers that are locally connected to projectors. In this scenario, a local user may set up the intermediary computer by, for example, setting up a screen sharing application on the intermediary computer and connecting the intermediary computer to projector 180, thereby effectively connecting device 110 to projector 180.

Instead, systems and methods disclosed herein may leverage infrastructure to automatically facilitate connections between device 110 and projector 180 to enable showing presentations 120 within physical space 160 without a complicated setup process involving a person physically present within physical space 160 to set up device 110 and/or projector 180. After reserving the physical space 160 via scheduling module 130, the user may receive a secret key from the scheduling module 130. The secret key may be received via the same infrastructure used to reserve physical space 160. By way of illustration, scheduling module 130 may be incorporated into an organization's email-based system for managing room reservations. Here, the scheduling module may be a set of scripts operating, for example, in association with an Exchange server. Consequently, when a user sends an email or meeting request to an email address associated with a physical space 160, the scheduling module may determine whether any time conflicts exist and whether the user has appropriate permissions. Subsequently, the email service may block off the time to prevent conflicts from occurring in the future, and send an email back to the user indicating that physical, space 160 has been reserved. This email may include the secret key.

When the user seeks to begin displaying presentation 120 within physical space 160, device 110 may attempt to connect to a control device 170. In this example, control device 170 is illustrated within physical space 160. In other examples, control device 170 may be located remotely. Control device 170 may be, for example, a system-on-a-chip that acts as an intermediary between device 110 and projector 180 to facilitate showing images received from device 110 on display 185.

To connect to control device 170, device 110 may provide the secret key received from scheduling module 130 to control device 170. Consequently, scheduling module 130 may also make the secret key available to control device 170 (e.g., by providing the secret key to the control device). In various examples device 110 may provide the secret key to control device 170 via a screen sharing module. The screen sharing module may be obtained from an external sever (not shown) associated with scheduling module 130 and/or control device 170. In some examples, a hyperlink in an email may cause device 110 to access a website that runs the screen sharing module (e.g., as a web based application). Consequently, the screen sharing module may be a device agnostic module that may operate without prior special configuration of device 110, control device 170, and/or projector 180. The screen sharing module may then use the secret key to connect device 110 with control device 170. In another example, the screen sharing module may operate as an add-on to, or be retrieved by, another application (e.g., web browser, email client) already operating on device 110.

In various examples, the secret key may serve as a security measure that prevents improper access to control device 170 and projector 180. Because scheduling module 130 may ensure that users reserving physical space 160 have corresponding access permissions, secret keys may be sent to persons approved to use physical space 160 and/or projector 180. Additionally, the secret key may be provided to control device 170 for a limited time period associated with the reservations. This may deter, for example, a user who has reserved physical space 170 from extending their meeting past the end of their reservation into a time period associated with another reservation. The limited time period for which the secret key may function may depend on various factors. By way of illustration, scheduling module 130 may provide the secret key to control device 170 for exactly the time period associated with the reservation. In other examples, scheduling module 130 may extend a window during which the secret key functions to accommodate setup time and/or a meeting running beyond a reservation period. Extended windows may be avoided in scenarios where two reservations operate in consecutive time periods.

Once device 110 has connected to control device 170 by providing control device 170 the secret key, control device may configure projector 180 to facilitate displaying images received from device 110. Configuring projector 180 may include, for example, turning on projector 180, changing display settings on projector 180, setting an input mode of projector 180, and so forth. After configuring projector 180, control device 170 may continue serving as an intermediary between device 110 and projector 180 to facilitate showing presentation 120 into physical space 160. When control device 170 is capable of turning on projector 180, control device 170 may also be able to turn off projector 180 once device 110 is no longer seeking to show images into physical space 160 via projector 180.

Various components of FIG. 1 may connect via a variety of different networks. By way of illustration, device 110 may be located remotely to physical space 160. Consequently, if control device 170 operates within a private network 150, device 110 may connect to private network 150 via public network 140. In this example, scheduling module 130 may operate within private network 150, within another private network (not shown), and so forth. In other examples, control device 170 may operate on a network separate from projector 180 as control device 170 may operate more effectively on a public network, whereas projector 180 may operate more securely on a private network.

It is appreciated that, in the following description, numerous specific details are set forth to provide a thorough understanding of the examples. However, it is appreciated that the examples may be practiced without limitation to these specific details. In other instances, methods and structures may not be described in detail to avoid unnecessarily obscuring the description of the examples. Also, the examples may be used in combination with each other.

“Module” as used herein, includes but is not limited to hardware, firmware, software stored on a computer-readable medium or in execution on a machine, and/or combinations of each to perform a function(s) or an action(s), and/or to cause a function or action from another module, method, and/or system. A module may include a software controlled microprocessor, a discrete module, an analog circuit, a digital circuit, a programmed module device, a memory device containing instructions, and so on. Modules may include one or more gates, combinations of gates, or other circuit components. Where multiple logical modules are described, it may be possible to incorporate the multiple logical modules into one physical module. Similarly, where a single logical module is described, it may be possible to distribute that single logical module between multiple physical modules.

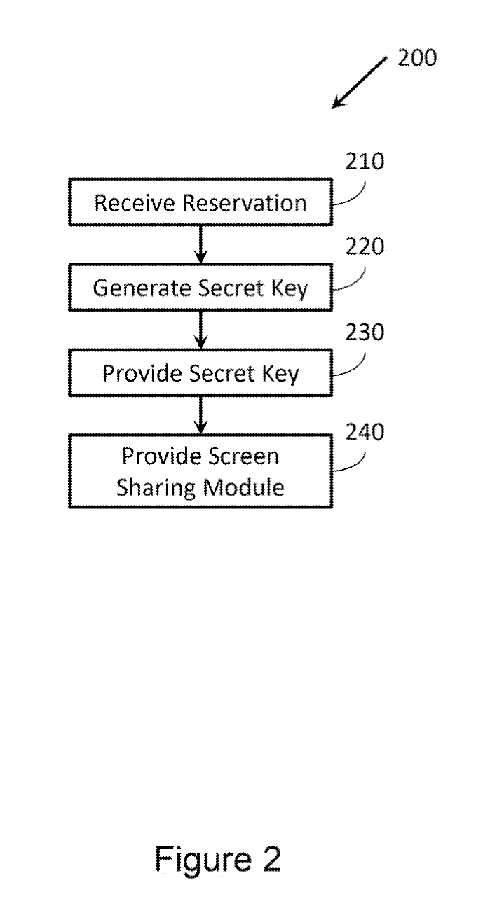

FIG. 2 illustrates an example method 200 associated with projection device access. Method 200 may be embodied on a non-transitory computer-readable medium storing computer-executable instructions. The instructions, when executed by a computer, may cause the computer to perform method 200. In other examples, method 200 may exist within logic gates and/or RAM of an application specific integrated circuit (ASIC).

Method 200 includes receiving a reservation request at 210. The reservation request may be received from a user. The reservation request may be for a meeting space. The reservation request may also be associated with a specified time period. The meeting space may have a projection device. In one example, the reservation request of the meeting space may be received via an email service. The projection device may be, for example, a projector, a display (e.g., television screen), and so forth.

Method 200 also includes generating a secret key at 220. The secret key may be generated based on the reservation request. The secret key may be generated using, for example, a cryptographic function, a programmatic function, and so forth.

Method 200 also includes providing the secret key at 230. The secret key may be provided to the user. In the example where the reservation request of the meeting space is received via an email service, the secret key may be provided to the user via that email service. In one example, the secret key may be provided to the user by providing a hyperlink associated with the secret key. The hyperlink may direct a web browser operating on the device to obtain a screen sharing module. In another example, an enhancement (e.g., add-on) to an application operating on a device to execute a screen sharing module may direct retrieval of the screen sharing module.

Method 200 also includes providing a screen sharing module at 240. The screen sharing module may be provided to the user (e.g., by allowing the user to download the screen sharing module to the device executing the screen sharing module). The screen sharing module may connect to the projection device using the secret key. The screen sharing module may also control the projection device to project an image into the meeting space. The image may be received from a device executing the screen sharing module. The image may be, for example, a screen associated with the device executing the screen sharing module, a portion of a screen associated with the device executing the screen sharing module, presentation slides received from the device executing the screen sharing module, and so forth.

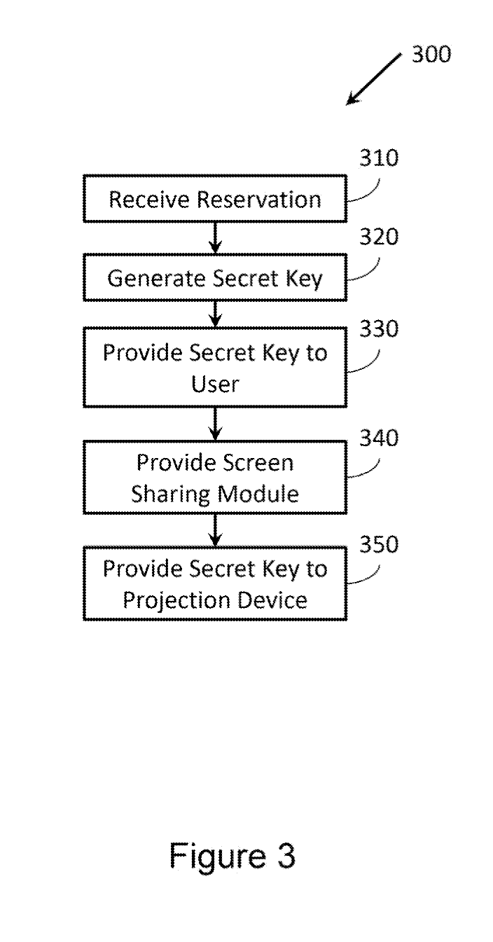

FIG. 3 illustrates a method 300 associated with projection device access. Method 300 includes several actions similar to those described above with reference to method 200 (FIG. 2). For example, method 300 includes receiving a reservation request from a user at 310, generating a secret key at 320, providing the secret key to the user at 330, and providing a screen sharing module to the user at 340.

Method 300 also includes providing the secret key to the projection device at 350. The secret key may be provided to the projection device during the specified time period. Providing the secret key to the projection device during the specified time period may facilitate time limited functionality of the secret key.

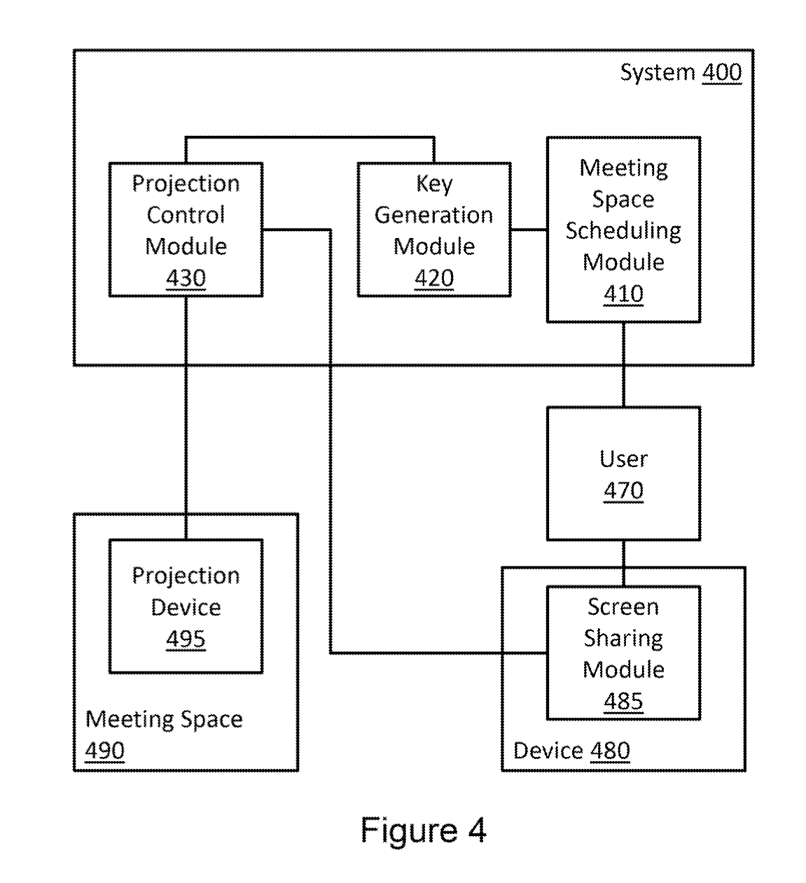

FIG. 4 illustrates a system 400. System 400 includes a meeting space scheduling module 410. Meeting space scheduling module 410 may manage reservations associated with a meeting space 490. Meeting space scheduling module 410 may manage reservations for meeting space 490 by, for example, ensuring users have appropriate permissions when scheduling reservations, preventing scheduling of conflicting reservations, and so forth. in one example, meeting space scheduling module 410 may be an email server.

System 400 also includes a key generation module 420. Key generation module 420 may provide a secret key to a user 470 when user 470 schedules a reservation in meeting space 490 (e.g., via meeting space scheduling module 410). The secret key may be provided for a projection device 495 in meeting space 490. In the example where meeting space scheduling module 410 operates in conjunction with an email server, key generation module 420 may provide the secret key to user 470 via the email server. In some examples, key generation module 420 may be able to determine additional meeting attendees based on the reservation. In these examples, key generation module 420 may also provide the secret key to the additional attendees.

System 400 also includes a projection control module 430. Projection control module 430 may, facilitate projection of an image by projection device 495 into meeting space 490. Projection control module 430 may facilitate this projection upon receiving the secret key from a screen sharing module 485 operating on a user device 480. The image projected by projection device 495 may be received from user device 480 via screen sharing module 485. In one example, projection control module 430 may operate on a system-on-a-chip attached to projection device 495. In this example, upon providing access to screen sharing module 485, projection control module 430 may adjust settings on projection device 495. Adjusting settings on projection device 495 may include, for example, turning on projection device 495, setting a resolution on projection device 495, setting an input source of projection device 495, and so forth. In some examples, screen sharing module 485 and projection control module 430 may operate on separate networks.

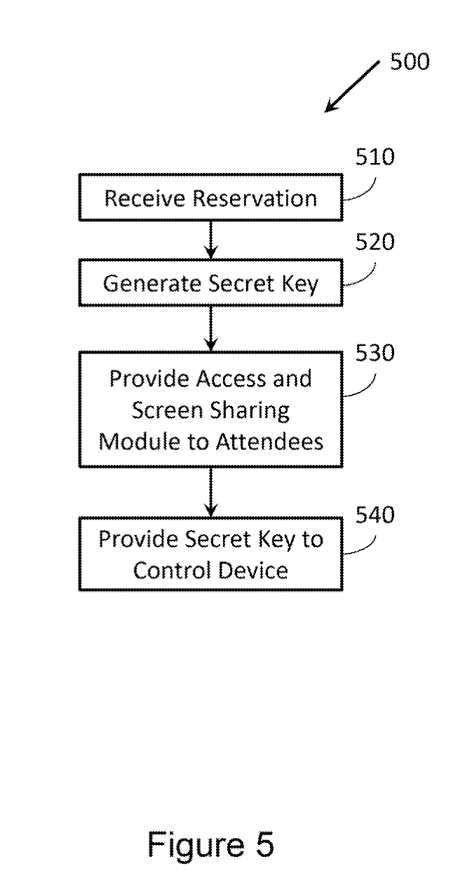

FIG. 5 illustrates an example method 500 associated with projection device access. Method 500 may be embodied on a non-transitory computer-readable medium storing computer-executable instructions, The instructions, when executed by a computer, may cause the computer to perform method 500. In other examples, method 500 may exist within logic gates and/or RAM of an application specific integrated circuit (ASIC).

Method 500 includes receiving a reservation request at 510 The reservation request may be received from a user. The reservation request may be for a meeting space. The reservation request may also be for a time period. The meeting space may have a projection device.

Method 500 also includes generating a secret key to the projection device at 520. Method 500 also includes providing the secret key and a screen sharing modules to attendees associated with the reservation request at 530. Attendees may include, a user who provided the reservation request received at action 510, persons the user invited when creating the reservation request, and so forth. The screen sharing module may facilitate transmitting images from devices to the projection device.

Method 500 also includes providing the secret key to a control device at 540. The control device may be associated with the projection device. The secret key may be provided during the time period. Providing the secret key to the control device may facilitate connecting the screen sharing module to the projection device during the time period. Securely connecting the screen sharing module to the projection device may facilitate displaying an image from a device operating the screen sharing module.

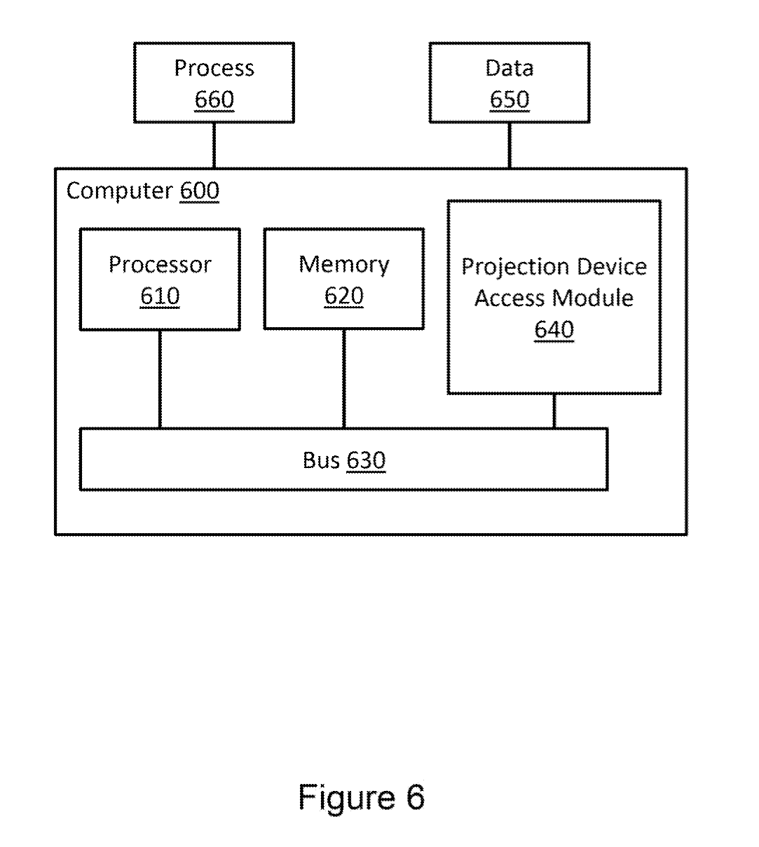

FIG. 6 illustrates an example computing device in which example systems and methods, and equivalents, may operate. The example computing device may be a computer 600 that includes a processor 610 and a memory 620 connected by a bus 630. The computer 600 includes a projection device access module 640. Projection device access module 640 may perform, alone or in combination, various functions described above with reference to the example systems, methods, apparatuses, and so forth. In different examples, projection device access module 640 may be implemented as a non-transitory computer-readable medium storing computer-executable instructions, in hardware, software, firmware, an application specific integrated circuit, and/or combinations thereof.

The instructions may also be presented to computer 600 as data 650 and/or process 660 that are temporarily stored in memory 620 and then executed by processor 610. The processor 610 may be a variety of various processors including dual microprocessor and other multi-processor architectures. Memory 620 may include non-volatile memory (e.g., read only memory) and/or volatile memory (e.g., random access memory). Memory 620 may also be, for example, a magnetic disk drive, a solid state disk drive, a floppy disk drive, a tape drive, a flash memory card, an optical disk, and so on. Thus, memory 620 may store process 660 and/or data 650. Computer 600 may also be associated with other devices including other computers, peripherals, and so forth in numerous configurations (not shown).

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A method, comprising:
receiving, from a user, a reservation request of a meeting space for a specified time period, the meeting space having a projection device;
generating a secret key based on the reservation request;
providing the secret key to the user; and
providing a screen sharing module to the user, the screen sharing module to:
connect to the projection device using the secret key; and
control the projection device to project an image into the meeting space, the image received from a device executing the screen sharing module.

2. The method of claim 1, comprising:
providing the secret key to the projection device during the specified time period to facilitate time limited functionality of the secret key.

3. The method of claim 1, where the reservation request of the meeting space is received via an email service, and where the secret key is provided to the user via the email service.

4. The method of claim 1, where providing the secret key to the user comprises providing a hyperlink associated with the secret key, the hyperlink to direct a web browser to obtain the screen sharing module.

5. The method of claim 1, where an enhancement to an application operating on the device executing the screen sharing module directs retrieval of the screen sharing module.

6. The method of claim 1, where the projection device is one of a projector and a display.

7. A system, comprising:
a meeting space scheduling module to manage reservations associated with meeting space;
a key generation module to provide, to a user when the user schedules a reservation in the meeting space, a secret key for a projection device in the meeting space; and
a projection control module to, upon receiving the secret key from a screen sharing module operating on a device, facilitate projection of an image by the projection device, the image received from the device via the screen sharing module.

8. The system of claim 7, where the meeting space scheduling module operates in conjunction with an email server and where the key generation module provides the secret key to the user via the email server.

9. The system of claim 7, where the projection control module operates on a system-on-a-chip attached to the projection device, and where the projection control module, upon providing access to the screen sharing module, adjusts a setting on the projection device.

10. The system of claim 9, adjusting the setting on the projection device comprises one or more of, turning on the projection device, setting a resolution on the projection device, and setting an input source, of the projection device.

11. The system of claim 7, where the key generation module also provides the secret key to additional attendees associated with the reservation.

12. The system of claim 7, where the screen sharing module and the projection control module operate on separate networks.

13. The system of claim 7, where the meeting space scheduling module manages reservations for the meeting space by ensuring that users have appropriate permissions when scheduling reservations and preventing scheduling of conflicting reservations.

14. A non-transitory computer-readable medium storing computer-executable instructions that when executed by a computer cause the computer to:
receive a reservation request of a meeting space for a time period, the meeting space having a projection device;
generate a secret key to the projection device;
provide, to attendees associated with the reservation request, the secret key and a screen sharing module that facilitates transmitting images from devices to the projection device; and
provide, during the time period, the secret key to a control device associated with the projection device to facilitate securely connecting the screen sharing module to the projection device during the time period.

15. The non-transitory computer-readable medium of claim 14, where securely connecting the screen sharing module to the projection device facilitates displaying an image from a device operating the screen sharing module.
